(19) United States
(12) Patent Application Publication
(10) Pub. No.: US 2026/0361608 A1
(43) Pub. Date: Nov. 12, 2026

(54) LAYERED INTENT MANAGEMENT FRAMEWORK ARCHITECTURE

(71) Applicant: InterDigital Patent Holdings, Inc., Wilmington, DE (US)

(72) Inventors: Kevin DI LALLO, Laval (CA); Michel ROY, Candiac (CA); Catalina MLADIN, Hatboro, PA (US); Ulises OLVERA-HERNANDEZ, Saint-Lazare (CA); Taimoor ABBAS, Sainte-Julie (CA)

(73) Assignee: InterDigital Patent Holdings, Inc., Wilmington, DE (US)

(21) Appl. No.: 19/203,028

(22) Filed: May 8, 2025

(51) Int. Cl. H04L 41/14; H04L 41/16

(52) U.S. Cl. CPC H04L 41/14; H04L 41/16

(57) ABSTRACT

In some implementations, a method may be performed by a network node including receiving a configuration for one or more supported intents including intent information for each of the one or more supported intents. The method may include receiving an intent discovery request having discovery criteria for available intents, and determining a set of available intents by comparing the discovery criteria with the first configuration. The method may include sending an intent discovery response having the set of available intents, and receiving a request to activate a first intent. The method may include creating a first intent instance and determining a system configuration corresponding to the intent instance. The method may include sending, in accordance with the first system configuration, at least one of: the first system configuration to a 3GPP system, or an intent activation request to a subsystem network node of the 3GPP system.

### BACKGROUND

The modern communications field has experienced rapid evolution, spurred by the increasing complexity of network functions and the need for greater automation. Existing systems often rely on intricate, multi-step processes to manage communication network operations. Networks today are expected to handle a multitude of services while integrating and coordinating disparate functionalities seamlessly. As networks evolve towards supporting more dynamic and flexible service environments, there is a growing need to address the challenges caused by complex operational procedures.

An autonomous network is a network that can operate without or with limited human intervention. An autonomous network can configure, monitor, and maintain itself independently, typically with the aid of AI/ML systems. Such systems may collect and analyze data from the network and make dynamic operational decisions to optimize network efficiency, adaptability and quality of service.

Current 3GPP systems have begun adopting technologies that may enable autonomous network deployments by introducing data collection and analytics services, and by enabling AI/ML services. Next generation networks are expected to continue this trend by offering unified and simplified APIs and by adding support for intent-based networking.

Network exposure refers to the exposure of network functionality and information either internally to network functions or externally to other entities. In current 3GPP systems, network exposure may involve several procedural cross-layer APIs and may require several ordered (e.g., sequential) API calls to accomplish a task. This places a burden on the API consumer to understand the details of several APIs, to understand the differences between diverse MNO deployments, and to monitor and adapt to any API changes. The lack of abstraction between network APIs and API consumers complicates API usage and may result in lower adoption rates and sub-optimal network utilization.

To reduce network exposure API complexity and to alleviate the burden on API consumers, intent-based service exposure may be used. By migrating to intent-based service exposure, a simplified API may be exposed to API consumers allowing the API consumers to provide network requirements as an intent rather than a set of specific API calls. This shifts the complexity of managing multiple cross-layer network API calls to the API provider, where knowledge of the network is already established. At the same time, granular network API exposure is maintained to enable complex and ever-changing use cases and deployments.

Work has been done in current 3GPP systems (e.g., 5G systems) to enable intent-based service exposure of the Management Subsystem (MnS). It is expected that next generation systems (e.g., 6G systems) will enable intent-based service exposure of additional network subsystems. It is also expected that next generation systems will consolidate and simplify network exposure by including support for unified and intent-based network exposure. Thus, the need exists for technological solutions allowing a 3GPP system to support an exposure framework architecture to enable unified and intent-based network exposure across the network.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving a first configuration for one or more supported intents, the first configuration having intent information and access permissions for each of the one or more supported intents. The method may also include receiving, from an intent requestor, an intent discovery request having discovery criteria for one or more available intents. The method may furthermore include determining a set of available intents by comparing the discovery criteria for the one or more available intents with the one or more supported intents. The method may in addition include sending, to the intent requestor, an intent discovery response having the set of available intents. The method may moreover include receiving, from the intent requestor, a request to activate a first intent from the set of available intents. The method may also include creating a first intent instance and determining a first system configuration corresponding to the first intent instance. The method may furthermore include in accordance with the first system configuration, at least one of: the first system configuration to a network element of a 3rd Generation Partnership Project (3GPP) system, or an intent activation request to a subsystem network node of the 3GPP system. Other embodiments of this aspect include corresponding computer systems, apparatus, and computer programs recorded on one or more computer storage devices, each configured to perform the actions of the methods.

Implementations may include one or more of the following features. The method where creating the first intent instance may include: verifying the intent requestor is authorized to activate the first intent and there are no conflicts with the first intent; and assigning an intent identification (ID) to the first intent instance. The method where the first configuration further may include access permissions for each of the one or more supported intents, and where the discovery criteria may include at least one of: intent requestor information, user information, or discovery filters, and where the intent information may include at least one of: a respective intent identifier for each of the one or more supported intents, a respective intent group identifier for a group of the of the one or more supported intents, a respective intent name for each of the one or more supported intents, a respective intent type for each of the one or more supported intents, a respective intent category for each of the one or more supported intents, a respective intent description for each of the one or more supported intents, or a respective intent objective for each of the one or more supported intents. The method may include: receiving wireless transmit/receive unit (WTRU) subscription and location information from a 3rd Generation Partnership Project (3GPP) system; and determining a subset of the one or more supported intents based on the WTRU subscription and location information. The method may include: determining a first intent monitoring configuration based on intent activation information associated with the first intent instance; sending, to the intent requestor, a second response having an activation status of the first intent; monitoring the 3GPP system according to the first intent monitoring configuration; determining a first event associated with the first intent instance based on the monitoring; and sending, to the intent requestor, a first notification associated with the first event. The method where the first configuration is received from an intent provider, where the intent provider is at least one of: a second network node, or a wireless transmit/receive unit (WTRU), and where the intent requestor is at least one of: a network functional entity, an application server, an enabler server with intent requesting function (IRF) capabilities, or a wireless transmit/receive unit (WTRU). The method where the activation status of the first intent may include at least one of: an intent activation response, activation status information, one or more reasons for activation failure, or first intent instance information including an intent instance identification. The method where monitoring the 3GPP system may include at least one of: creating an intent monitoring task (IMT), or invoking commands or intents, either alone or in combination, associated with one or more 3GPP system application programming interfaces (APIs) or subsystem intent management functions (IMFs). The method where the first intent monitoring configuration may include invoking commands or intents, either alone or in combination, associated with one or more 3GPP system application programming interfaces (APIs) or subsystem intent management functions (IMFs). The method where the first network node is an intent management framework having at least one of: an intent management core component (IMCC), an intent semantics component (ISC), an intent activation task (IAT), an intent monitoring task (IMT), or an intent repository. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of an intent management framework;

FIG. 3 illustrates an example of an intent instance lifecycle;

FIG. 4 illustrates an example procedure for discovering and activating available intents;

FIG. 5 illustrates an example procedure for activating available intents using an intent management framework;

FIG. 6 illustrates an example procedure for discovering and activating available intents via an Anchor IMF;

FIG. 7 illustrates an example procedure for discovering available intents via an Exposure IMF;

FIG. 8 illustrates an example procedure for monitoring intents and intent instances;

FIG. 9 illustrates an example procedure for monitoring intents and intent instances using an intent management framework; and

FIG. 10 is a flowchart of an example network-based intent management process.

### DETAILED DESCRIPTION

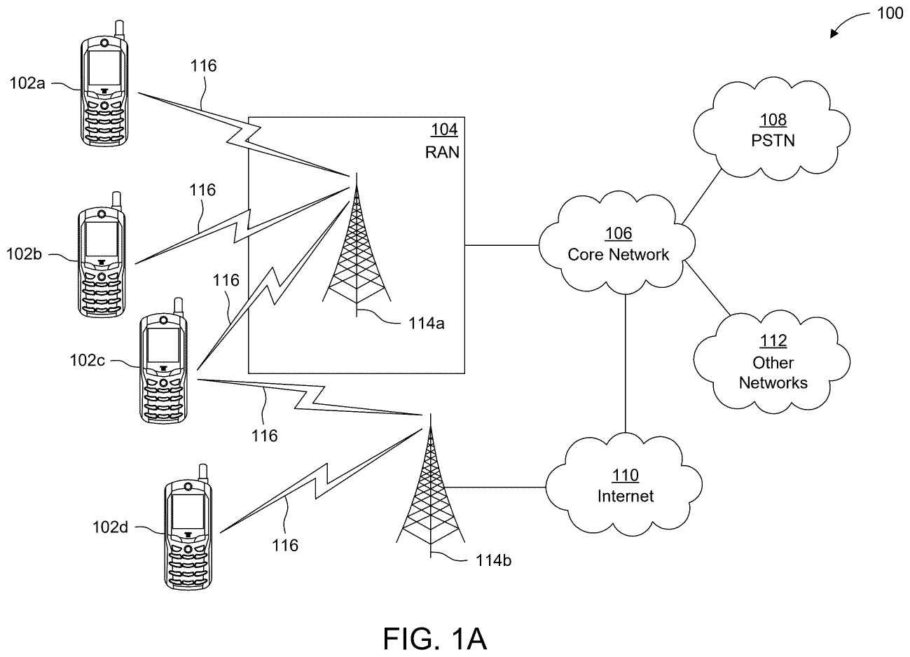

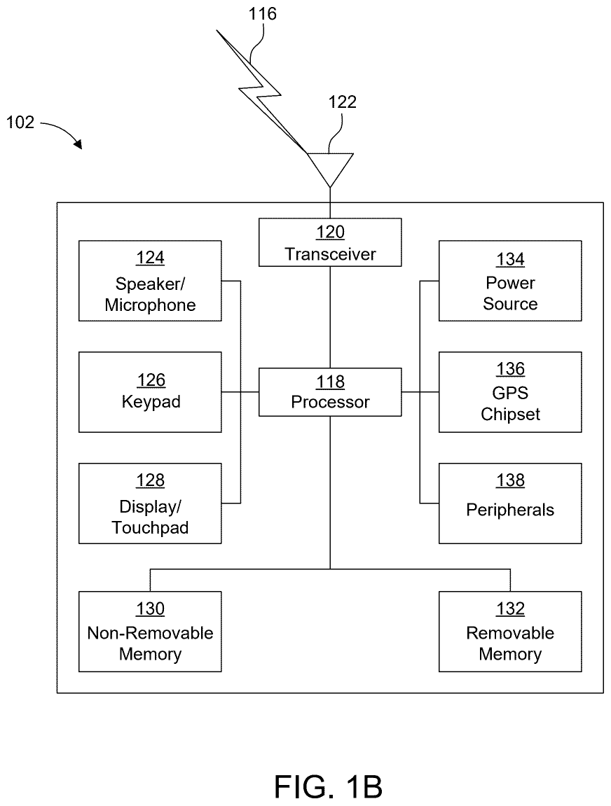

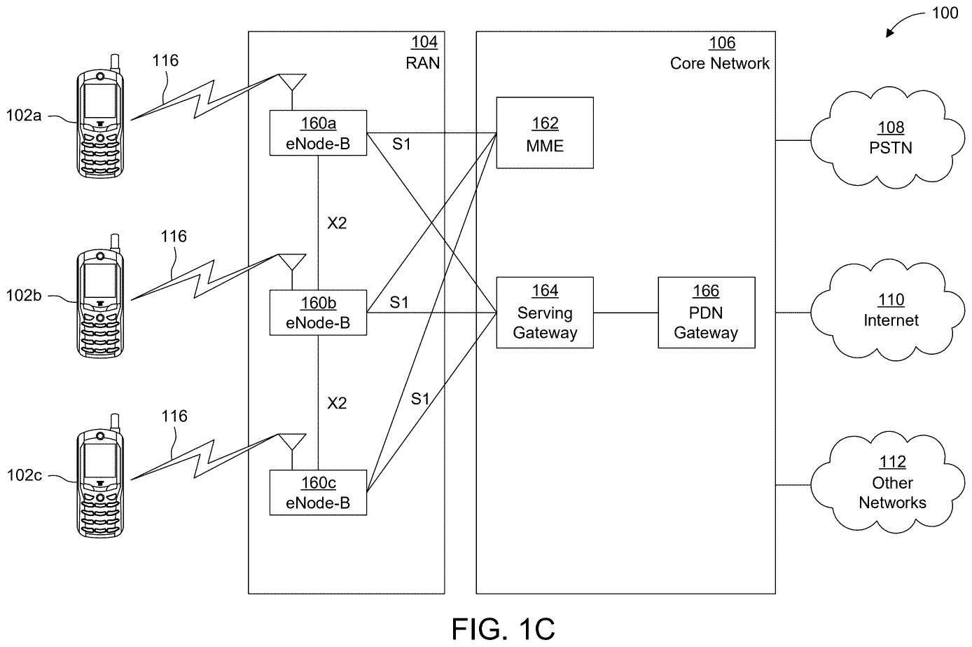

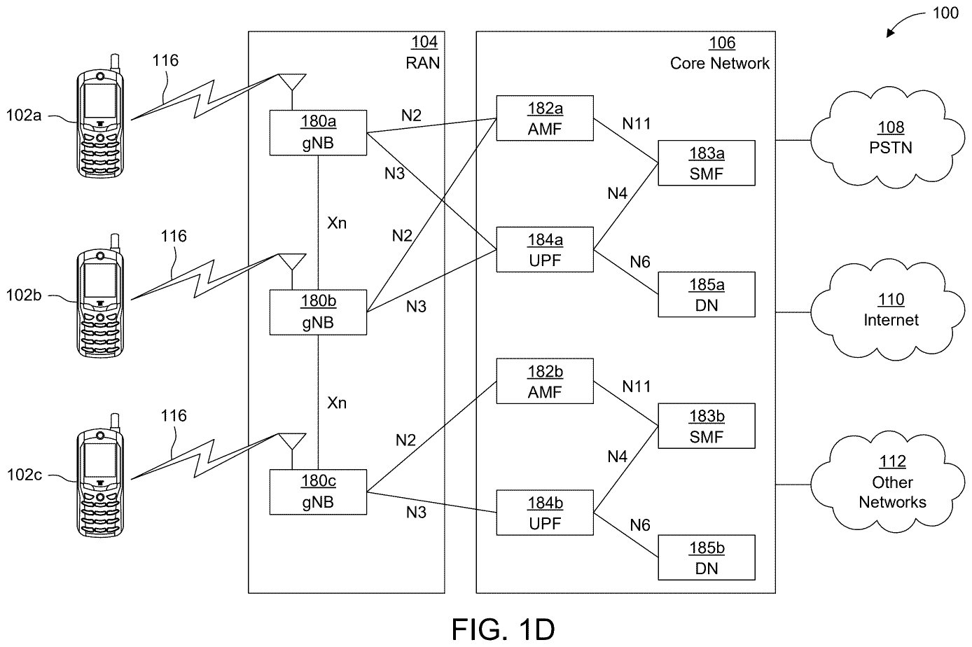

The following acronyms may be referred to in the description that follows:
3GPP 3rd Generation Partnership Project
5 5th Generation
5GC 5G Core Network/5G Core
5GS 5G System
6G 6th Generation
6GC 6G Core Network/6G Core
6GS 6G System
AC Application Client
API Application Programing Interface
AS Application Server
CAPIF Common API Framework
CCF CAPIF Core Function
CN Core Network
DN Data Network
DNN Data Network Name
GPSI Generic Public Subscription Identifier
IAT Intent Activation Task
ID Identifier
IMCC Intent Management Core Component
IMF Intent Management Function
IMT Intent Monitoring Task
IP Internet Protocol
IRF Intent Requesting Function
ISC Intent Semantics Component
ISG Industry Specification Group
MNO Mobile Network Operator
NEF Network Exposure Function
NF Network Function
PDU Protocol Data Unit
PLMN Public Land Mobile Network
QoE Quality of Experience
QoS Quality of Service
SBI Service-Based Interface
S-NSSAI Single Network Slice Selection Assistance Information
SUPI Subscription Permanent Identifier
TS Technical Specification
UE User Equipment
FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A network-based intent management is described herein. The solutions described solve the problems that current 3GPP systems require API consumers to understand several complex network APIs to obtain a desired service. API consumers must also be aware of different API implementations and configurations when dealing with multiple network operators.

Proposed solutions include a new intent management framework and architecture and a new network function (e.g., an Intent Management Function (IMF)), as an enhancement to the 3GPP system, to enable unified and intent-based network exposure. The IMF may manage intent-based requests within the network and across network layers.

In an embodiment a first network node (e.g., a network functional entity, an application server, or an enabler server, with IMF capabilities) may perform the following actions to manage intents.

The first network node may receive a first configuration with one or more supported intents to configure supported intents. For example, the first configuration may be pre-configured in the first network node, or the first configuration may be received from an intent provider.

The intent provider may be a second network node (e.g., a network functional entity, an application server, or an enabler server), or the intent provider may be a first UE (e.g., a UE functional entity, an application client, or an enabler client). The first configuration may be provided to an IMF of the first network node.

The first configuration may include information about supported intents, information about available intents, and information about an intent management function or task.

The first network node may receive a first request to discover available intents. For example, the first request may be an Intent Discovery request. The first request may be received from an intent requestor, and the intent requestor may be a third network node (e.g., a network functional entity, an application server, or an enabler server, with IRF capabilities).

In an example, the intent requestor may be a second UE (e.g., a UE functional entity, an application client, or an enabler client, with IRF capabilities).

The first request may be provided to the IMF of the first network node, and the first request may include information about the intent requestor, and intent discovery filters.

The first network node may determine a list of supported intents that are available to the intent requestor. The determination may be based on comparing and/or matching the information received in the first request with information from the first configuration.

The first network node may send a first response to the intent requestor to inform the intent requestor about the available intents. The first response may be an Intent Discovery response. In an example. the first response may include information about the determined available intents.

The first network node may receive a second request to activate a first intent. The second request may be an Intent Activation request. In an example, the second request may be received from the intent requestor.

The second request may be provided to the IMF of the first network node. In an example, the second request may include information about the intent requestor, intent activation information associated with the first intent, and intent monitoring information associated with the first intent.

The first network node may activate the first intent. In an example, the first network node may verify that the intent requestor is authorized to activate the first intent. The first network node may validate that the first intent does not conflict with any other active intents.

The first network node may create a first intent instance and assigns an intent instance ID to the first intent instance. The first network node may determine a first system configuration based on intent activation information associated with the first intent, and the first network node may determine a first intent monitoring configuration based on intent monitoring information associated with the first intent.

The first network node may configure the 3GPP system according to the first system configuration. The first network node may create an Intent Activation Task (IAT) to configure the 3GPP system. In an example, the first network node may invoke commands and/or intents with one or more 3GPP system APIs and/or subsystem IMFs.

The first network node may send a second response to the intent requestor to inform the intent requestor about the intent activation status. The second response may be an Intent Activation response. In an example, the second response may include information about the activation status, a reason for activation failure, and information about the first intent instance. Information about the first intent instance may include an intent instance ID.

The first network node may monitor the 3GPP system according to the first intent monitoring configuration. In an example, the first network node may create an Intent Monitoring Task (IMT) to monitor the 3GPP system. The first network node may invoke commands and/or intents with one or more 3GPP system APIs and/or subsystem IMFs.

The first network node may determine a first event associated with monitoring of the first intent instance. In an example, the determination is based on intent monitoring information associated with the first instance. The first network node may determine a second system configuration based on intent monitoring information associated with the first instance.

The first network node may configure the 3GPP system according to the second system configuration. In an example, the first network node may invoke commands and/or intents with one or more 3GPP system APIs and/or subsystem IMFs.

The first network node may send a first notification to the intent requestor to inform the intent requestor about the first event. In an example, the first notification may be a Monitoring Event notification. The first notification may include event information.

As described above, an autonomous network is a network that can operate without or with limited human intervention, and can configure, monitor, and maintain itself independently, typically with the aid of AI/ML systems. Such systems may collect and analyze data from the network and make dynamic operational decisions to optimize network efficiency, adaptability and quality of service.

Also, 3GPP systems have begun adopting technologies that may enable autonomous network deployments by introducing data collection and analytics services, and by enabling AI/ML services. It is expected that next generation networks will continue this trend by offering unified and simplified APIs and by adding support for intent-based networking.

Intent-based networking (IBN) is a network management approach that considers consumer and operator objectives rather than traditional network configuration requirements. These objectives are known as intents. An intent describes a desired outcome as opposed to the traditional approach where focus is on the means of achieving a desired outcome.

An IBN network obtains intents from network consumers and/or operators and translates the intents into list of actions and/or policies that can be applied to the network. The IBN network may use AI/ML systems to generate optimal list of actions and/or policies for achieving both consumer and network operator objectives.

The IBN network may activate an intent by performing a list of actions and/or a policy. This intent activation results in configuring the network to operate in a way that meets the consumer and network operator objectives. The IBN network may monitor network operation to ensure that the network is behaving as intended. The IBN network may use analytics services and/or traditional network and device APIs to obtain the information required to evaluate network performance. Corrective actions may be determined based on network analytics and monitoring.

3GPP systems support a service-based architecture with service-based interfaces (SBIs) for core network functions, application enablers and the management system. These SBIs correspond to APIs that specify information elements that can be configured by an API consumer. An API consumer must be aware of the supported information elements and their impact on the network in order to efficiently use the API. The responsibility of achieving an objective is assigned to the API consumer and it is assumed that the API consumer knows how to use the network APIs and knows how to combine the network APIs together to achieve an objective; in other words, the network is agnostic about the API consumer objective and simply executes the API calls made by an API consumer independently.

Intent-based service exposure relies on intents to expose functionality. Intents allow an API consumer to convey a desired objective or outcome rather than specifying a specific network configuration or combining a sequence of API calls. The intent exposure framework can interpret an intent and transforms it into a list of actions and/or policy and can activate these actions and/or policies. This abstracts the network inner workings from the API consumer and allows the API provider to configure the network optimally. 3GPP systems are beginning to support intent-based service exposure. For example, the 3GPP management system supports intent driven management services for mobile networks as described in 3GPP TS 28.312.

In current 3GPP systems, network exposure may involve several procedural cross-layer APIs and may require several ordered (e.g., sequential) API calls to accomplish a task placing a burden on the API consumer to understand the details of several APIs, to understand the differences between diverse MNO deployments, and to monitor and adapt to any API changes. The lack of abstraction between network APIs and API consumers complicates API usage which may result in lower adoption rates and sub-optimal network utilization.

The solutions described herein include techniques to enable unified and intent-based network exposure. The proposed solutions are necessary to reduce API usage complexity for API consumers by abstracting network operation details, and to optimize network utilization by maintaining operational control in the Mobile Network Operator (MNO) domain. An Intent Management Function (IMF) is proposed, as an enhancement to the 3GPP system, to manage intent-based requests within the network and across network layers.

In the proposed solutions, an Intent Requesting Function (IRF) communicates with an IMF to discover supported and available intents, activate selected intents and monitor intent fulfillment. IMF procedures are proposed for intent provisioning, intent discovery, intent activation, intent monitoring, and intent instance lifecycle management.

An application client (AC) is an application that resides on a UE or WTRU and communicates with an Application Server (AS). A WTRU may use several ACs concurrently.

An application server (AS) is an application server that resides in a Data Network (DN) and, typically, may be a software server executing on generic hardware and providing a service to an AC or to another AS. An AS may serve one or more AC instances that may reside on different WTRUs, and one or more AS instances that may reside in different DNs.

An enabler client (EC) is a service enabler that resides on a WTRU, that communicates with an ES and that provides client-side functionalities to ACs for a specific enablement service.

An enabler server(ES) is a service enabler that resides in a DN and provides server-side functionalities to ASs for a specific enablement service. An ES may serve one or more EC instances that may reside on different WTRUs, and may serve one or more ES instances (e.g., with client-side functionalities) that may reside in different DNs.

WTRU information is information that characterizes a WTRU. WTRU Information may include a WTRU identifier (e.g., SUPI, GPSI, phone number), WTRU state, and WTRU capabilities.

Requestor information is information that characterizes a requestor. Requestor information may include a user identifier (e.g., unique ID), an application identifier (e.g., unique ID, type-specific ID), an application type, a network function identifier (e.g., NF ID), WTRU information, security credentials and a notification endpoint.

System configuration information is information that characterizes a configuration for a 3GPP system. System configuration information may include one or more policies associated with the 3GPP system (e.g., service enablement policies, core network policies, WTRU policies), a set of actions (e.g., commands, API calls, subsystem intent activations) to take on the 3GPP system, and action configuration information associated with the actions. Action configuration information may include configuration values associated with each action, an API address (e.g., URL, URI, IP address, port, endpoint) associated with each action, an order in which actions should be taken, a time associated with actions to be taken, and dependencies between actions. System configuration information may be stored in a NF (e.g., PCF, NWDAF) and may be provisioned in the IMF by the NF (e.g., via a NEF), may be pre-configured in the IMF, or may be dynamically generated using AI/ML capabilities that are locally stored and/or provisioned in IMF.

Intent information is information that characterizes an intent. Intent information may include an intent identifier (e.g., unique ID, type-specific ID), an intent group identifier (e.g., unique group ID), an intent name, an intent type, an intent category, and an intent description, which may be a semantic description of an intent. An intent's objective may further describe what is the desired outcome of an intent and may describe how to measure that outcome.

In some systems, intents may be described semantically, and the semantic description of an intent may be interpreted at the system level and translated dynamically into a list of actions required to achieve the objective. In some systems, intents may be described procedurally, and the procedural description of an intent may be a list of actions required to achieve the objective.

It should be understood that defining intents procedurally or semantically is an implementation option and that a system may support both procedural and semantic intents. For that purpose, characteristic intent information such as intent type may be mapped to semantic domains (e.g. via associated ontologies), applicable network layers or network subsystems, trust domains, AI models, etc. Such mappings may be pre-configured or enabled to be dynamically updated.

It should also be understood that a list of supported intents may be provisioned in a system to limit and control the possible intents. When supported intents are provisioned in a system, an intent user may discover the supported intents and may activate one or more supported intents as required.

Intent activation information is information that characterizes an activation configuration for an intent instance. Intent activation information may include configuration values associated with an intent, and may include information (e.g., numeric or text values, identifiers, addresses, timer values where the start and stop time could be monitored at the requestor or producer of the intent, etc.) that may be used for configuring the 3GPP system.

In some systems, intent group activation information may be used to characterize the activation configuration for grouped intent instances. The same activation and deactivation information may be used for the entire group of intent instances.

Intent monitoring information is information that characterizes a monitoring configuration for an intent instance. Intent monitoring information may include a monitoring policy for the intent instance, and system configuration information for monitoring the 3GPP system. The monitoring policy may include rules specifying detection criteria and associated actions to take. Detection criteria may include intent state changes, data thresholds, and analytics thresholds and/or events. Actions may include updating the system configuration information, and reporting monitored events. The monitoring policy may also include a reporting frequency and periodicity. System configuration information may include rules and configuration for monitoring system events, data and analytics.

Event information is information that characterizes a monitored event. Event information may include an event identifier (e.g., a unique ID), an event type, an event description, and event-specific information. For example, event specific information may include intent state changes, exceeded or unmet data and analytics thresholds, etc.

Intent instance information is information that characterizes an intent instance. Intent instance information may include an intent instance identifier (e.g., unique ID), an intent instance state, requestor information, user information, WTRU information, intent information, intent activation information, and intent monitoring information. Multiple Intent instances may be grouped together and may be identified using an intent group identifier (e.g., unique group ID).

Intent Lifecycle refers to the duration for which an intent instance is active and the intent lifecycle states are further described with reference to an IMF. Some intents may have a short lifecycle, for example an intent for obtaining information from the network may be short-lived until the information is provided to the requestor. Some intents may have a long lifecycle, for example an intent for establishing a QoS session may be long-lived from the session establishment until the session is completed according to the session duration.

The techniques and solutions described herein include enhancements to the 3GPP system to enable a layered intent-based network exposure (e.g., across network layers). For example, enhancements may include functionality for intent provisioning, intent discovery, intent activation, intent monitoring, and intent instance lifecycle management. These enhancements are defined in an Intent Management Function (IMF), described herein. An IMF may provide services to an Intent Requesting Function (IRF).

The IMF provides an API that allows an IRF to perform intent management operations with the IMF (e.g., discover, activate, monitor, terminate, etc.). The IRF may discover the IMF service API via the methods provided by the network. Discovered service APIs may be based on an IRF capability to support intent-based APIs. Discovered service APIs may include an indication that a service API is intent-based. For example, the IRF may discover the IMF service API via CAPIF if the network supports CAPIF and the IMF API has been published with the CCF. Alternatively, the IRF may discover the IMF service via the NRF if the IMF has registered its service with the NRF. Alternatively, if the IRF is a WTRU, the WTRU may be provided with the IMF connectivity information at network registration time. When the WTRU registers with the network, it may receive connectivity information of the IMF service via the PCO in the registration accept response sent by the network to the WTRU after the registration is complete. Alternatively, the WTRU (e.g., acting as an IRF), may request IMF connectivity during the establishment of a PDU Session (e.g., by providing an IMF specific DNN/S-NSSAI). One skilled in the art should understand that the provided examples are for illustrating how the IMF service may be discovered and that other examples are possible (e.g., DNS discovery, edge application server discovery, etc.).

Intent Management Framework (IMF) functionality may be divided into intent management components and tasks. The set of intent management components and tasks may be referred to as an intent management framework. An intent management framework may perform the functions of an IMF. The terms “Intent Management Function” and “intent management framework” may be used interchangeably herein.

Intent management components and tasks may include an intent management core component, an intent semantics component, an intent activation task, an intent monitoring task, and an intent repository.

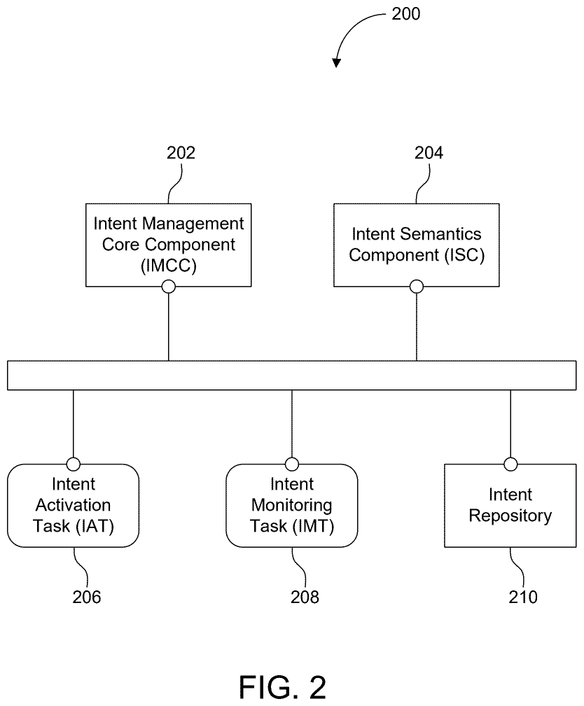

FIG. 2, illustrates an example of an intent management framework 200.

An Intent Management Core Component (IMCC) 202 is responsible for managing core capabilities of the intent management framework. Core capabilities may include exposing intents and intent-based service APIs supported by the intent management framework, providing IMF services for intent management, managing the lifecycle of intent instances, resolving intent instance conflicts, and creating and configuring intent management framework tasks (e.g., IAT, IMT). When triggered by an IRF intent activation request, the IMCC 202 may create an intent instance and may trigger operations in other components and tasks of the intent management framework. For example, the IMCC 202 may request the ISC 204 to interpret a semantic intent, the IMCC 202 may store the newly created intent instance in an intent repository, the IMCC may request the IAT 206 to activate an intent, and IMCC 202 may request IMT 208 to monitor the activation status and operation status of the activated intent.

IMCC 202 may be configured with AI/ML capabilities that may enable better intent interpretation and ambiguity resolution. For example, common language intents may be ambiguous or may conflict with other intents. Context aware AI models may help to distinguish intents and to prioritize conflicting intents.

An Intent Semantics Component (ISC) 204 is responsible for interpreting semantic intents (e.g., intents that are described semantically) and dynamically translating semantic intents into a list of actions required to achieve the intent objective.

An Intent Activation Task (IAT) 206 is responsible for configuring the 3GPP system according to the system configuration information associated with an intent instance. The system configuration information may be determined by IAT 206 or may be provided to IAT 206 by the IMCC 202. The system configuration information may be pre-configured or dynamically generated using AI/ML capabilities. IAT 206 may deploy policies, determine a list of actions, and perform the determined actions according to system configuration information. IAT 206 may invoke commands and/or intents with one or more APIs and/or subsystem IMFs. It should be understood that the IAT 206 lifecycle may be limited to the duration required for the execution of a determined list of actions and that the IAT 206 may be idle or completed once the list of actions has been executed.

An Intent Monitoring Task (IMT) 208 is responsible for monitoring the 3GPP system according to the intent monitoring information associated with an intent instance. The intent monitoring information may be determined by IMT 208 or may be provided to IMT 208 by the IMCC 202. The intent monitoring information may be pre-configured or dynamically generated using AI/ML capabilities. IMT 208 installs the policies and performs the actions provided in the system configuration information from the intent monitoring information. The IMT 208 may invoke commands and/or intents with one or more APIs and/or subsystem IMFs. The IMT 208 may enforce the monitoring policy from the intent monitoring information. The IMT 208 may detect system state changes, may report information about state changes to the IMCC 202, may detect exceeded data and analytics thresholds, and may trigger updates to the system configuration information associated with the intent instance. It should be understood that the IMT 208 lifecycle may be according to the intent lifecycle (e.g., short or long) and that the IMT 208 may be idle or completed once the intent is terminated.

An Intent Repository 210 is responsible for storing intent information for supported intents, and for storing intent instance information. The intent repository may support the standard create, read, update, and delete functions of a repository.

The techniques and solutions described herein include enhancements to the 3GPP system to enable layered intent management. For example, enhancements may include functionality for an IMF to activate and monitor intents in another IMF, register intents with another IMF, discover available intents from another IMF, proxy intent activation and monitoring requests to another IMF, and expose available intents from another IMF.

The proposed solutions support intent lifecycle management. Intent instance lifecycle states may include the Activating, Operating, Deactivating, and Completed states.

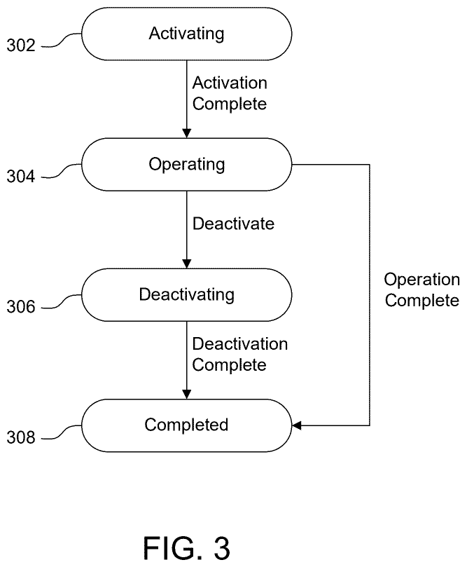

FIG. 3 illustrates an example of an intent instance lifecycle.

During intent activation, an intent instance may be created. The initial state for a newly created intent instance is the Activating state 302. In the Activating state 302, the IMF may determine the required system configuration information and intent monitoring information described herein. The IMF may determine a list of actions and perform these actions to configure the 3GPP system using the determined system configuration information. Once activated, an intent instance may transition from the Activating state 302 to the Operating state 304.

In the Operating state 304, the IMF may monitor the activated intent using the determined intent monitoring information; this may include configuring the 3GPP system to obtain information required for the intent monitoring. The IMF may monitor the underlying system to determine whether the intent instance is fulfilling its intended objectives. If the intent instance does not fulfill the intended objectives, the IMF may take corrective measures (e.g., update the required system configuration) and continue to monitor the system. The intent instance remains in the Operating state 304 until the intent is deactivated or until the intent operation has completed. If an active intent instance is deactivated, the intent instance may transition from the Operating state 304 to the Deactivating state 306. If an active intent instance operation is completed, the intent instance may transition from the Operating state 304 to the Completed state 308.

In the Deactivating state 306, the IMF may remove any system configuration associated with the intent instance being deactivated and may stop monitoring the 3GPP system for the intent instance. Once intent instance deactivation is complete, the intent instance may transition from the Deactivating state 306 to the Completed state 308.

In the Completed state 308, the intent instance may be terminated and destroyed. It should be appreciated that the information about an instance that has been completed may be maintained in the system for traceability reasons. Some systems may allow intents instances to transition (not shown) from the Completed state 308 to the Activating state 302, in such case, the intent instance identifier may be used to re-activate a terminated instance. The benefit of such re-activation may be to reduce configuration overhead and provide an efficient intent activation flow.

In a 3GPP system, an IRF may be an application on a WTRU (e.g., AC), an application in a network (e.g., AS), an application enablement client on a WTRU (e.g., EC), an application enablement server in a network (e.g., ES), a network component on a WTRU, and/or a core network function in a network. In the 3GPP system, an IMF may be an application enablement client on a WTRU (e.g., EC), an application enablement server in a network (e.g., ES), a network component on a WTRU, and/or a core network function in a network.

The IMF functionality may be deployed as a single functional entity or as a set of functional components and tasks. A set of functional components and tasks performing the functions of an IMF may be referred to as an intent management framework.

Functional components and tasks of an intent management framework may be an application enablement client on a WTRU (e.g., EC), an application enablement server in a network (e.g., ES), a network component on a WTRU, and/or a core network function in a network.

Functional components and tasks of an intent management framework may be collocated (e.g., fully collocated, partially collocated) or separated. The IRF and/or IMF functionality may be packaged in a library that is statically linked with an application, application enabler, or NF. In an embodiment, the IRF and/or IMF functionality may be packaged in a library that is dynamically loaded by an application, application enabler, or NF.

The IMF services may be offered using a communication protocol. For example, the Hyper Text Transfer Protocol (HTTP) for 3GPP systems may provide access to the capabilities of the IMF services.

Intent discovery and activation may be performed using an IMF.

The proposed solutions support intent discovery and activation. Intent discovery and activation enable an IRF in the network or on a WTRU to discover intents that are supported by the IMF and that are available to the IRF.

For intent discovery, the IMF may identify configured (e.g., pre-configured or provisioned by an intent provider) intents that match the discovery criteria provided by the IRF. The IMF returns the list of available intents to the IRF. The IRF may then select and activate one or more intents from the list of discovered intents. It should be understood that systems supporting semantic intents may not require or support intent discovery, and that the semantic intent information may be provided by the IRF and interpreted or translated by the IMF accordingly.

For intent activation, the IMF validates the selected intent and creates an intent instance, this may include translating the semantic intent into a list of actions or retrieving a procedural intent list of actions from the intent repository. The IMF processes the intent and determines system configuration information and system monitoring information to associate with the intent instance. The IMF then performs the list of actions to configure the 3GPP system using the determined system configuration information and informs the IRF that the intent activation is complete. Finally, the IMF uses the system monitoring information to configure monitoring of the 3GPP system to ensure that the intent instance objectives are fulfilled as intended.

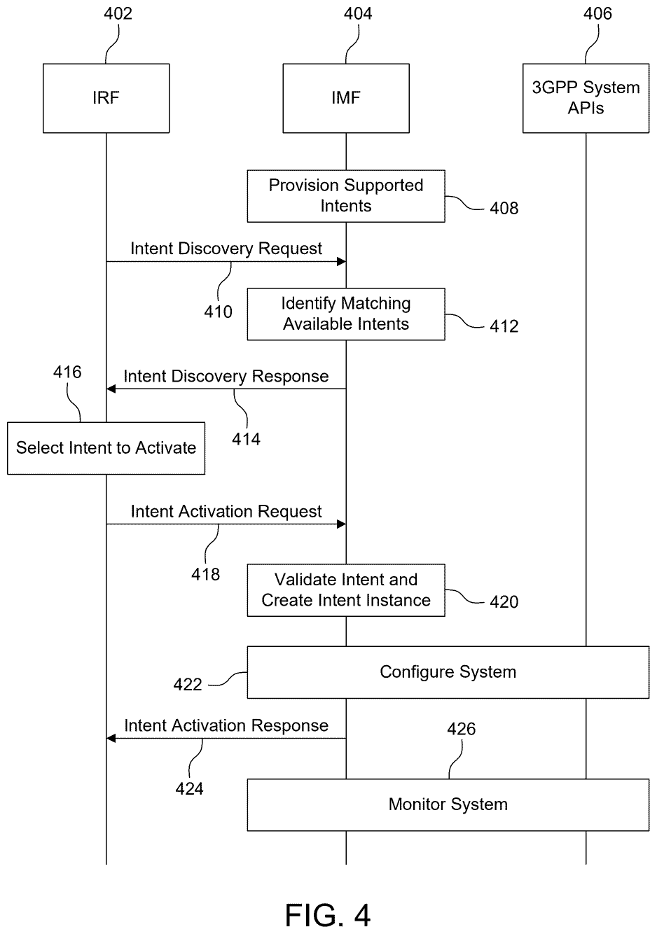

FIG. 4 illustrates an example procedure for discovering and activating available intents.

As a prerequisite, an IRF 402 has discovered an IMF 404 and has obtained the necessary credentials to invoke the intent-based API of IMF 404.

At 408, IMF 404 is provisioned with a configuration for one or more supported intents. The configuration may include intent information and intent access permissions for supported intents. The configuration may be pre-configured in IMF 404 or may be obtained by IMF 404 via communication with an intent provider. The intent provider may register its supported intents with IMF 404, or IMF 404 may query the supported intents from the intent provider. IMF 404 may store the configuration locally or in a separate storage entity (e.g., an intent repository or broker).

For example, a new network function (NF) in the core network may offer quality of experience (QoE) management services via an intent-based service API. The new NF may be pre-configured with a set of supported intents. The new NF may discover available services and service capabilities in the core network. The new NF may determine that only a subset of the supported intents is currently available.

At 410, the IRF 402 discovers intents that are supported by IMF 404 and that are available to IRF 402. IRF 402 may send an Intent Discovery request to IMF 404 to discover available intents. The request may include information about IRF 402, user information, and intent discovery filters. Information about IRF 402 may include requestor information described herein. User information may include WTRU information described herein. Intent discovery filters may include intent information described herein.

For example, an AS in the network may send an Intent Discovery request to an intent-based NEF API to discover available intents for QoS management. The request may include information about the requesting AS and may include intent discovery filters indicating a need to discover QoS-related intents. The request may include information about the WTRU for which QoS is intended to be requested.

At 412, IMF 404 uses the information in the Intent Discovery request to identify intents that are supported by IMF 404, authorized for the requestor and/or WTRU, and that match the intent discovery filters provided by IRF 402 in the Intent Discovery request. IMF 404 compares the information received in the Intent Discovery request with the provisioned configuration for supported intents. IMF 404 may additionally invoke core network APIs (e.g., via the NEF) as described in 3GPP TS 23.502 to obtain WTRU subscription and location information, and the IMF 404 may use this information to determine which intents a user is allowed to activate. IMF 404 identifies matching intents that are available to IRF 402.

For example, an IMF may determine that there are several intents related to QoS management supported by the IMF and for which the IRF has permission to activate. The IMF may select which matching intents to make available to the IRF.

In another example, an IMF may obtain WTRU location and user subscription information from the core network and may determine that a subset of the supported intents is available to the IRF. This determination may be based on the user subscription information and current WTRU location.

At 414, IMF 404 sends an Intent Discovery response to the requesting IRF 402 to inform IRF 402 about the discovered intents that are available to IRF 402. The response may include intent information for the intents identified by IMF 404. The response may include a service API address (e.g., URL, URI, IP address, port) for one or more services where the intent is available. If no available intents are discovered, IMF 404 may send an empty list and a discovery status code in the response.

For example, an IMF may provide, to the IRF, a list of intents related to QoS management that are available to the IRF and a list of service API endpoints where QoS management intents are available. QoS management intents may indicate that an intent supports QoS guarantees for one or more WTRUs for accessing a service in a DN.

At 416, IRF 402 selects an intent to activate from the discovered intents. IRF 402 may select one or more intents from the list of available intents provided in the Intent Discovery response. Alternatively, IRF 402 may select a pre-configured or cached intent to activate.

At 418, IRF 402 sends an Intent Activation request to IMF 404 to activate an intent. The request may include information about IRF 402, user information, intent information for the selected intent, intent activation information for the selected intent, and intent monitoring information for the selected intent. Information about IRF 402 may include requestor information described herein. User information may include WTRU information described herein.

For example, an AS in the network may send an Intent Activation request to an intent-based NEF API to activate an intent for QoS management. The request may include information about the requesting AS and may include intent activation information indicating a need to guarantee a certain QoS for a group of WTRUs when they are operating within a specified location area. The request may also include intent monitoring information indicating QoS thresholds below which remedial actions should be taken by the network and below which the IRF should be notified.

Although not shown in FIG. 4, this request may be replaced by an Intent Activation Update request to handle an intent instance activation update. The request must include an intent instance ID to identify the intent instance being updated, and may include updates to any information provided by IRF 402 in the Intent Activation request.

Although not shown in in FIG. 4, this request may be replaced by an Intent Deactivation request to handle an intent instance deactivation. The request must include an intent instance ID to identify the intent instance being deactivated.

At 420, IMF 404 validates and processes the intent activation request. IMF 404 uses the information provided in the Intent Activation request to verify that IRF 402 is authorized to activate the selected intent, and to verify that the selected intent does not conflict with existing intent instances. If the selected intent activation information conflicts with existing intent instances, IMF 404 determines whether there is a new and/or updated system configuration that can fulfill the intended objectives of the intent being activated and of the existing intent instances. If such a system configuration exists, IMF 404 determines the system configuration information updates and intent monitoring information updates required for each existing intent instance, and IMF 404 determines the system configuration information and intent monitoring information for the intent being activated.

IMF 404 creates a new intent instance and assigns an intent instance ID to the intent instance; upon creation of the intent instance, the intent instance enters the Activating state. IMF 404 stores the intent instance ID in the intent instance information of the intent instance. IMF 404 updates the intent instance information with the system configuration information and intent monitoring information associated with the newly created intent instance.

Although not shown in FIG. 4, for intent activation updates IMF 404 obtains the existing intent instance using the intent instance ID and updates the intent instance information using the same procedures as for the intent activation.

Although not shown in FIG. 4, for intent deactivation IMF 404 uses the intent instance ID to deactivate and terminate the intent instance.

At 422, IMF 404 configures the 3GPP system 406 according to the system configuration information from the intent activation information in the intent instance information. The system configuration information may be pre-configured, provisioned by IRF 402, or dynamically generated in IMF 404 using AI/ML capabilities. IMF 404 installs the policies in the 3GPP system 406 and performs the actions provided in the system configuration information. IMF 404 may invoke commands and/or intents with one or more APIs and/or subsystem IMFs, and IMF 404 may receive an indication of invocation success or failure.

Although not shown in FIG. 4, for intent deactivation IMF 404 removes the 3GPP system 406 configuration associated with the intent instance.

At 424, IMF 404 sends an Intent Activation response to the requesting IRF 402 to inform the IRF 402 about the intent activation status. The response may include intent instance information, an intent activation status, and an error code indicating a reason for intent activation failure in error cases. Upon completion of the activation of the intent instance, the intent instance enters the Operating state.

It should be understood that the Intent Activation response may be sent to the IRF before the intent instance activation is complete. This may occur in cases where system monitoring is required to complete intent activation. In this case, the IMF may start an activation timer. The timer value may be pre-configured in the IMF or based on intent activation information provided by the IRF. If the timer expires before intent activation is complete, the intent instance may be deactivated and the IRF may be notified.

At 426, IMF 404 begins monitoring the 3GPP system 406 according to the intent monitoring information from the intent instance information. The intent monitoring information may be pre-configured, provisioned by IRF 402, or dynamically generated in IMF 404 using AI/ML capabilities. IMF 404 installs the policies and performs the actions provided in the system configuration information from the intent monitoring information. IMF 404 may invoke commands and/or intents with one or more APIs and/or subsystem IMFs, and IMF 404 may receive an indication of invocation success or failure. IMF 404 may enforce the monitoring policy from the intent monitoring information. IMF 404 may detect and report information about state changes to IRF 402, may detect exceeded data and analytics thresholds, and may trigger updates to the system configuration information associated with the intent instance.

Although not shown in FIG. 4, for intent deactivation IMF 404 removes the 3GPP system 406 monitoring configuration associated with the intent instance.

The proposed solutions support intent activation using an intent management framework. The intent activation procedure highlights the interactions between components of the intent management framework during intent activation.

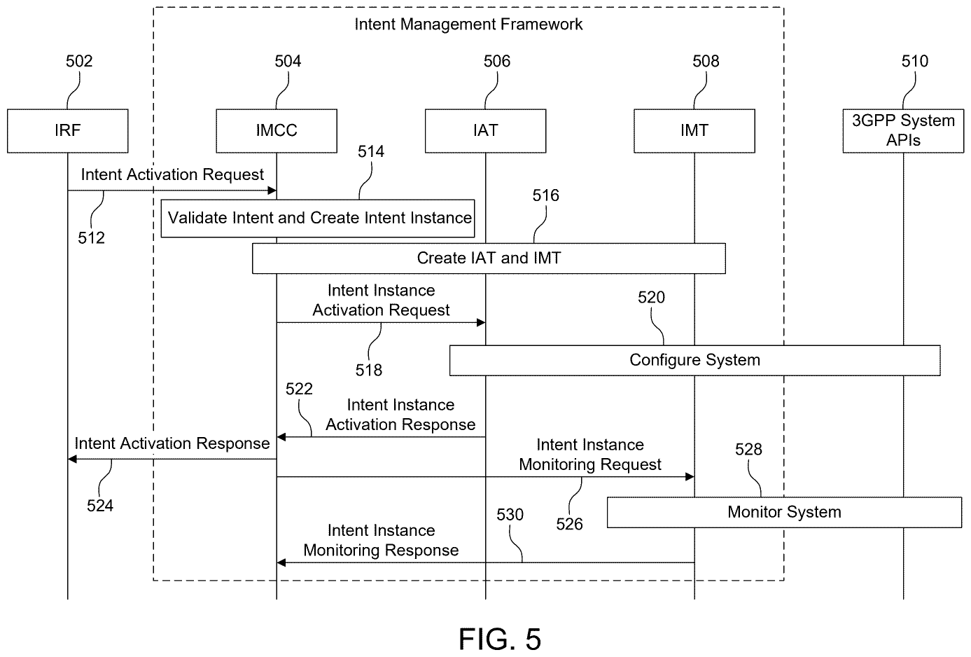

FIG. 5 illustrates an example procedure for activating available intents using an intent management framework.

As a prerequisite, IRF 502 has discovered an IMCC 504 and has obtained the necessary credentials to invoke the intent-based API of IMCC 504.

The process at 512 is the same as 418 of FIG. 4.

The process at 514 is the same as 420 of FIG. 4, with the exception that IMCC 504 performs the actions of the IMF (404 in FIG. 4). Although not shown in FIG. 5, IMCC 504 may store the intent information and the intent instance information in the Intent Repository. Also not shown in FIG. 5, IMCC 504 may send a request to the ISC to process any semantic intents and/or semantic intent descriptions.

At 516, IMCC 504 creates instances of the intent management tasks. The IMCC may create an IAT 506 instance and an IMT 508 instance or may re-use existing IAT and IMT instances that are available to support an intent activation. These instances may be collocated with IMCC 504 or may be deployed as separate functional entities. IAT 506 is responsible for executing a list of actions for configuring the 3GPP system 510 according to the system configuration information associated with an intent instance being activated. IMT 508 is responsible for monitoring the 3GPP system 510 according to the intent monitoring information associated with the intent instance being activated.

At 518, IMCC 504 sends an Intent Instance Activation request to IAT 506 to activate an intent instance. The request may include information about IMCC 504 and intent instance information, the request may include a list of actions that have been determined by IMCC 504, or alternatively the list of actions may be determined at IAT 506.

At 520, IAT 506 performs the list of actions to configure the 3GPP system 510 according to the system configuration information from the intent activation information in the intent instance information. If the request did not include a list of actions, IAT 506 may retrieve such list of actions associated with the intent from the intent repository or may dynamically generate the list of actions using AI/ML capabilities. The system configuration information may be pre-configured in IAT 506 or provided by IMCC 504 in the Intent Instance Activation request. IAT 506 installs the policies in the 3GPP system 510 and performs the actions provided in the system configuration information. IAT 506 may invoke commands and/or intents with one or more APIs and/or subsystem IMFs, and IAT 506 may receive an indication of invocation success or failure.

At 522, IAT 506 sends an Intent Instance Activation response to IMCC 504 to inform the IMCC 504 about the intent activation status. The response may include an intent activation status, and an error code indicating a reason for intent activation failure in error cases.

The process at 524 is the same as 424 of FIG. 4.

At 526, IMCC 504 sends an Intent Instance Monitoring request to IMT 508 to monitor an intent instance. The request may include information about IMCC 504 and intent monitoring information from the intent instance information.

At 528, IMT 508 begins monitoring the 3GPP system 510 according to the intent monitoring information from the intent instance information. The intent monitoring information may be pre-configured in IMT 508, provided by IMCC 504 in the Intent Instance Monitoring request, or dynamically generated in IMT 508 using AI/ML capabilities. IMT 508 installs the policies and performs the actions provided in the system configuration information from the intent monitoring information. IMT 508 may invoke commands and/or intents with one or more APIs and/or subsystem IMFs, and IMT 508 may receive an indication of invocation success or failure. IMT 508 may enforce the monitoring policy from the intent monitoring information. IMT 508 may detect system state changes, may report information about state changes to IMCC 504, may detect exceeded data and analytics thresholds, and may trigger updates to the system configuration information associated with the intent instance.

At 530, IMT 508 sends an Intent Instance Monitoring response to IMCC 504 to inform IMCC 504 about the intent monitoring status. The response may include an intent monitoring status, and an error code indicating a reason for intent monitoring failure in error cases.

The proposed solutions support intent discovery and activation via an Anchor IMF. The Anchor IMF discovers available intents from IMFs in different subsystems (e.g., Subsystem IMFs). The discovered intents may be referred to as subsystem intents. The Anchor IMF may expose the discovered subsystem intents using the Anchor IMF as a proxy, or the Anchor IMF may determine to expose new intents based on the availability of subsystem intents. An IRF may discover available intents from the Anchor IMF and may select an intent to activate. During activation, the Anchor IMF validates the selected intent and may create an intent instance. The Anchor IMF may determine that the intent instance requires the activation of one or more subsystem intents. The Anchor IMF may invoke the APIs of Subsystem IMFs to activate subsystem intents associated with the intent instance created by the Anchor IMF. Subsystem IMFs may then configure and monitor resources associated with the activated subsystem intent instances.

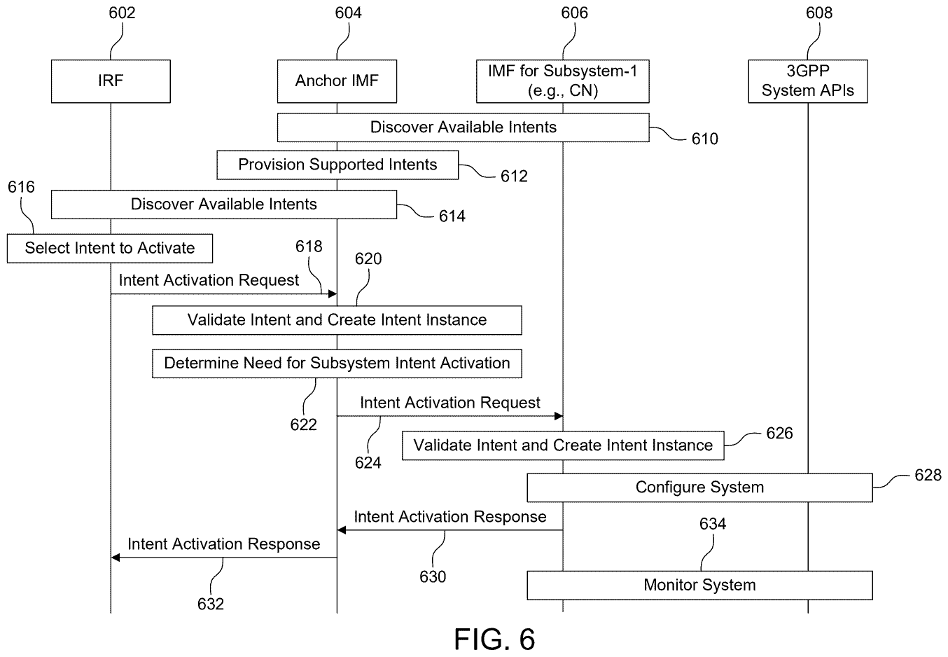

FIG. 6 illustrates an example procedure for discovering and activating available intents via an Anchor IMF.

As a prerequisite, an IRF 602 has discovered an Anchor IMF 604 and has obtained the necessary credentials to invoke the intent-based API of the Anchor IMF 604. At 610, the Anchor IMF 604 may discover available intents from a Subsystem IMF 606. Subsystem IMF 606 may register its supported intents with Anchor IMF 604, or Anchor IMF 604 may query the supported intents from the Subsystem IMF 606. When Anchor IMF 604 queries the supported intents from the Subsystem IMF 606, the Anchor IMF 604 performs the functions of an IRF for intent discovery. In this case, the process at 410 to 414 of FIG. 4 may be followed to discover available subsystem intents. Alternatively, Anchor IMF 604 may subscribe to receive supported intent notifications from the Subsystem IMF 606. Notifications may indicate added and/or removed supported intents in the Subsystem IMF 606.

One skilled in the art should understand that discovery of subsystem intents may also be triggered by an Intent Discovery request from an IRF, for example IRF 602.

For example, an Anchor IMF deployed in an Enable Server (ES) may send an Intent Discovery request to a Subsystem IMF deployed in a core network function. The request may include information about the requesting ES and may include intent discovery filters indicating a need to discover QoS-related intents. The request may include information about a group of WTRUs for which QoS is intended to be requested. The core network function may determine that a subset of its supported intents matches the discovery parameters provided by the ES. The core network function may return a list of available intents to the ES.

At 612, Anchor IMF 604 is provisioned with a configuration for one or more supported intents. The configuration may include intent information and intent access permissions for supported intents. The configuration may be pre-configured in Anchor IMF 604 or may be determined by Anchor IMF 604 based on discovered available intents (e.g., local to the Anchor IMF and from Subsystem IMFs) and current network state. Anchor IMF 604 may store the configuration locally or in a separate storage entity.

For example, a new NF in the core network may offer QoE management services via an intent-based service API. The new NF may be pre-configured with a set of supported intents. The new NF may discover available subsystem intents in the core network and may query network capabilities. The new NF may determine that only a subset of the supported intents is currently available.

The procedure at 614 to 620 are equivalent to the procedure at 410 to 420 of FIG. 4.

At 622, Anchor IMF 604 may determine that the intent instance requires the activation of one or more subsystem intents. Anchor IMF 604 may invoke the APIs of Subsystem IMFs (e.g., Subsystem IMF 606) to activate subsystem intents associated with the intent instance created by Anchor IMF 604.

The procedure at 624 to 630 are equivalent to the procedure at 418 to 424 of FIG. 4, wherein the Anchor IMF performs the functions of an IRF. The procedure at 632 is equivalent to the procedure at 424 of FIG. 4, and the procedure at 634 is equivalent to the procedure at 426 of FIG. 4.

The proposed solutions support intent discovery via an Exposure IMF. The Exposure IMF enables IMFs in different subsystems (e.g., Subsystem IMFs) to expose or publish supported intents to an IRF. Subsystem IMFs may register subsystem intents with an Exposure IMF. The Exposure IMF stores information about the registered intents and information about the Subsystem IMF associated with an intent. An IRF may discover available intents from the Exposure IMF and may select an intent to activate. The IRF may activate the selected intent by interacting directly with the Subsystem IMF where this intent is supported and available.

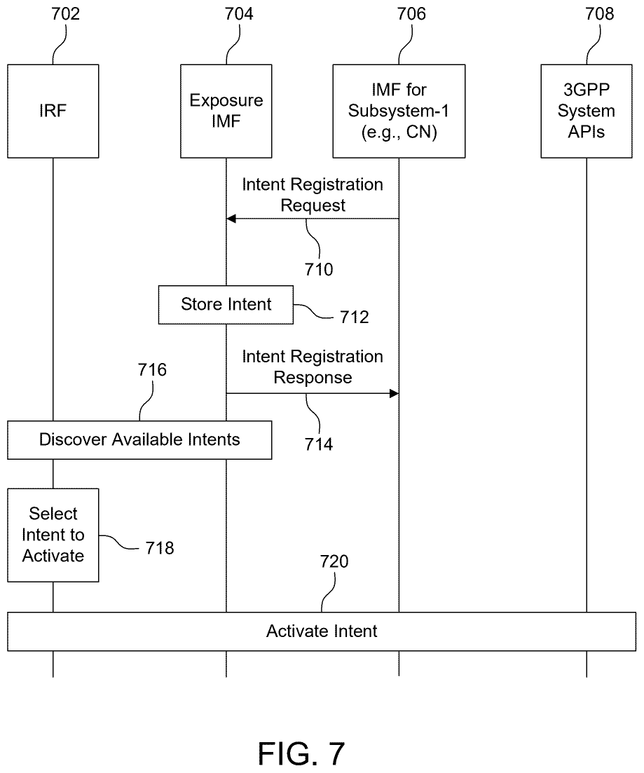

FIG. 7 illustrates an example procedure for discovering available intents via an Exposure IMF.

As a prerequisite, an IRF 702 has discovered an Exposure IMF 704 and has obtained the necessary credentials to invoke the intent-based API of the Exposure IMF 704.

At 710, a Subsystem IMF 706 may register intents with an Exposure IMF 704. Subsystem IMF 706 may send an Intent Registration request to Exposure IMF 704 to expose subsystem intents. The request may include information about the Subsystem IMF 706, intent information, and intent access permissions for the supported intents. Information about the Subsystem IMF 706 may include an API address (e.g., URL, URI, IP, port) for invoking the Subsystem IMF 706 intent-based API. Intent access permissions may include information about users and WTRUs that are authorized or forbidden to access (e.g., discover, activate, monitor) an intent, or location areas, service areas, and geographic areas within which WTRUs are allowed or forbidden to access (e.g., discover, activate, monitor) an intent.

At 712, Exposure IMF 704 may store the registered subsystem intents. Exposure IMF 704 creates a new intent registration and assigns an intent registration ID to the intent registration.

At 714, Exposure IMF 704 may send an Intent Registration response to Subsystem IMF 706 to inform the Subsystem IMF 706 about the intent registration status. The response may include an intent registration ID, an intent registration status, and an error code indicating a reason for intent registration failure in error cases.

At 716, IRF 702 discovers intents that are supported by Exposure IMF 704 and that are available to IRF 702. IRF 702 may send an Intent Discovery request to Exposure IMF 704 to discover available intents. The request may include information about IRF 702 and intent discovery filters. Information about IRF 702 may include requestor information described herein. Intent discovery filters may include intent information described herein.

Exposure IMF 704 uses the information in the Intent Discovery request to identify intents that are registered in the Exposure IMF 704, authorized for the requestor and/or WTRU, and that match the intent discovery filters provided by the IRF 702 in the Intent Discovery request. Exposure IMF 704 compares the information received in the Intent Discovery request with the registered subsystem intents. Exposure IMF 704 may additionally invoke core network APIs (e.g., via the NEF) as described in 3GPP TS 23.502 to obtain WTRU subscription and location information, and Exposure IMF 704 may use this information to determine which intents a user is allowed to activate. Exposure IMF 704 identifies matching intents that are available to IRF 702.

Exposure IMF 704 sends an Intent Discovery response to the requesting IRF 702 to inform IRF 702 about the discovered subsystem intents that are available to IRF 702. The response may include intent information for the intents identified by Exposure IMF 704. The response may include a service API address (e.g., FQDN, URI, IP, endpoint) for one or more services where the subsystem intent is available.

Alternatively, IRF 702 may subscribe to receive notifications from Exposure IMF 704 when a new intent is supported and/or available, and when an existing intent is updated or removed.

For example, The CAPIF Core Function (CCF) may perform the functions of an Exposure IMF. An AS in the network may send an Intent Discovery request to a CCF to discover available intents for QoS management. The request may include information about the requesting AS and may include intent discovery filters indicating a need to discover QoS-related intents. The CCF may identify a list of registered subsystem intents that match the requested parameters. The CCF may provide the list of discovered intents to the requesting AS. The discovered intents may include endpoint information associated with each available intent.

At 718, IRF 702 selects an intent to activate from the discovered intents. IRF 702 may select one or more intents from the list of available intents provided in the Intent Discovery response. Alternatively, IRF 702 may select a pre-configured or cached intent to activate.

At 720, IRF 702 activates the selected intent by invoking the intent-based API of the Subsystem IMF 706 that supports the selected intent. IRF 702 obtains the API address of Subsystem IMF 706 from the discovered subsystem intent information. IRF 702 performs the intent activation procedure with the Subsystem IMF 706 as described in the process at 418 to 426 of FIG. 4.

The proposed solutions support intent monitoring. Intent monitoring enables an IRF in the network or on a WTRU to monitor intents or intent instances. The IRF provides, to an IMF, information about the intents or intent instances to monitor, and a monitoring policy. When the IMF receives a request to monitor an intent instance, the IMF retrieves intent instance information for the intent instances to monitor. The IMF then determines a system configuration information for monitoring the intent instances. The determination may be based on the monitoring policy, 3GPP system state, and intent instances status. The IMF then performs the list of actions to configure the 3GPP system using the determined system configuration information and informs the IRF that the intent monitoring request has been processed.

While monitoring intent instances, the IMF may determine that a monitored intent or intent instance is impacted by a change in the IMF and/or 3GPP system. The determination may be based on detection criteria in the monitoring policy, monitoring events from the 3GPP system, and changes to activated intent instances. The IMF may determine that corrective actions are required in the 3GPP system to maintain fulfillment of all intent instances. The IMF may determine system configuration information updates to apply, may configure the 3GPP system according to the determined updates, and may notify the IRF about changes to monitored intent instances. The reporting criteria may be based on the monitoring policy.

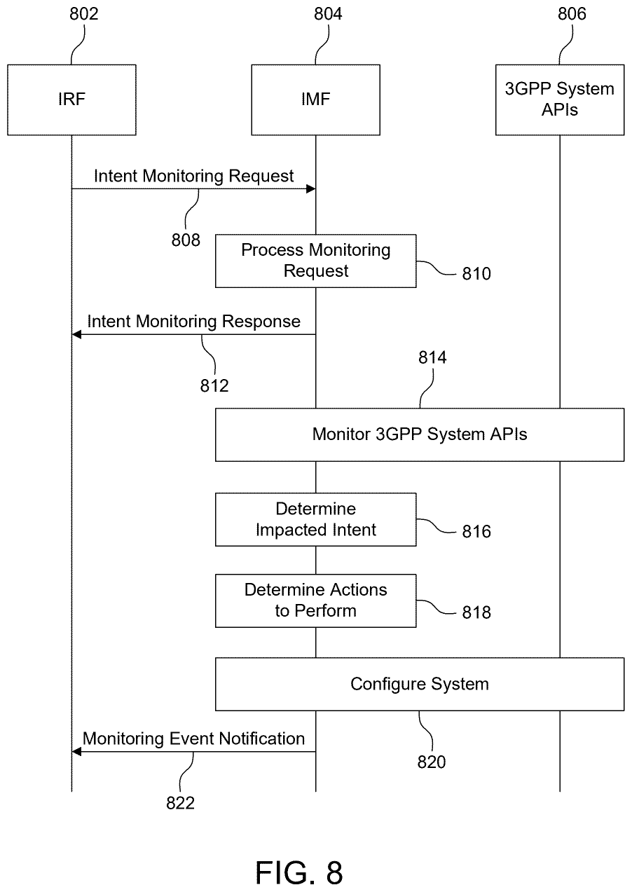

FIG. 8 illustrates an example procedure for monitoring intents and intent instances.

As a prerequisite, an IRF 802 has activated an intent using the procedure described in FIG. 4.

At 808, IRF 802 sends an Intent Monitoring request to IMF 804 to monitor an intent or intent instance. The request may include information about IRF 802, user information, intent information, intent instance information, and intent monitoring information described herein. Information about IRF 802 may include requestor information described herein. User information may include WTRU information described herein.

It should be understood that the Intent Monitoring request may be (e.g., may be combined with, may be replaced by) an Intent Activation request. For example, an IRF may monitor an intent instance that was activated in an IMF to guarantee a certain QoS for a group or WTRUs. The IRF may provide an intent instance identifier and a monitoring policy to the IMF indicating QoS thresholds below which corrective actions should be taken by the IMF and below which the IRF should be notified. The monitoring policy may also indicate that the IMF should provide periodic QoS reports to the IRF and that the IMF should notify the IRF of any changes to the intent instance.

In another example, an IRF may monitor a certain type of intent supported by the IMF. The IRF may provide intent monitoring information to the IMF indicating that the IRF should be notified of any new intent instances of the requested intent type. The monitoring policy may indicate that any state changes to intent instances of the requested intent type should be reported to the IRF.

At 810, IMF 804 validates and processes the intent monitoring request. IMF 804 uses the information provided in the Intent Monitoring request to verify that IRF 802 is authorized to monitor the selected intent or intent instance, and to retrieve intent instance information for intent instances that have been activated in IMF 804 and that match the intent instance identifiers received in the monitoring request.

IMF 804 determines the intent monitoring information for the intent instances being monitored. The intent monitoring information may be pre-configured in IMF 804, may be provided by IRF 802, or may be dynamically generated in IMF 804 using AI/ML capabilities. IMF 804 may update the monitored intent instance information to include the determined intent monitoring information.

IMF 804 may create a new monitoring instance and assign a monitoring ID to the monitoring instance. The monitoring ID may be included by IRF 802 in subsequent requests to IMF 804 to update or remove an intent monitoring instance.

At 812, IMF 804 sends an Intent Monitoring response to the requesting IRF 802 to inform IRF 802 about the intent monitoring status. The response may include a monitoring ID (e.g., a unique ID), intent instance information, an intent monitoring status, and an error code indicating a reason for intent monitoring failure in error cases.

It should be understood that the Intent Monitoring response may be (e.g., may be combined with, may be replaced by) an Intent Activation response.

At 814, IMF 804 begins monitoring the 3GPP system 806 according to the intent monitoring information associated with an intent instance. The intent monitoring information may be pre-configured in IMF 804, provisioned by IRF 802, or dynamically generated in IMF 804 using AI/ML capabilities. IMF 804 installs the policies and performs the actions provided in the system configuration information from the intent monitoring information. IMF 804 may invoke commands and/or intents with one or more APIs and/or subsystem IMFs, and IMF 804 may receive an indication of invocation success or failure.

At 816, IMF 804 may determine that an intent instance is impacted and requires IMF 804 actions. The determination may be based on system monitoring output, on other intent instances, and on detection criteria described herein. The detection criteria may be included in the monitoring policy in the intent monitoring information. Detection criteria may include intent state changes, data thresholds, analytics thresholds and/or events, etc.

At 818, IMF 804 may determine a set of actions to perform to maintain fulfillment of all intent instances. Actions to perform may be based on the monitoring policy provided by IRF 802, and may be associated with detection criteria in the monitoring policy. Actions to perform may include updating and applying the system configuration information associated with intent instances, and reporting monitoring events to IRF 802. The system configuration information may be pre-configured in IMF 804, provided by IRF 802 in the monitoring policy, or dynamically generated in IMF 804 using AI/ML capabilities. The system configuration information updates may be based on the monitoring policy, 3GPP system state, and intent instances status. The reporting criteria may be based on the monitoring policy.

At 820, IMF 804 may configure the 3GPP system 806 according to the system configuration information from the determined actions to perform. IMF 804 installs the policies in the 3GPP system 806 and performs the actions provided in the system configuration information. IMF 804 may invoke commands and/or intents with one or more APIs and/or subsystem IMFs, and IMF 804 may receive an indication of invocation success or failure.

At 822, IMF 804 may send a Monitoring Event notification to IRF 802 to report monitoring events. The Monitoring Event notification may include intent information for the impacted intents, intent instance information for the impacted intent instances, and event information described herein. The reporting criteria, frequency, and periodicity may be based on the monitoring policy.

The proposed solutions support intent monitoring using an intent management framework. The intent monitoring procedure highlights the interactions between components of the intent management framework during intent monitoring.

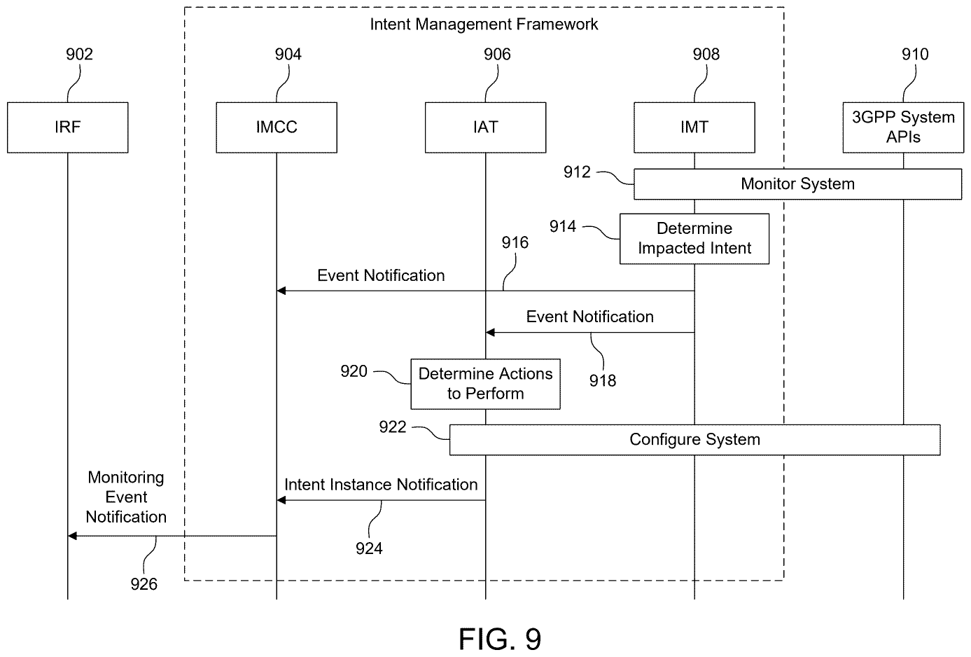

FIG. 9 illustrates an example procedure for monitoring intents and intent instances using an intent management framework.

As a prerequisite, an IRF 902 has activated an intent using the procedure described in FIG. 5, and IRF 802 has provided, to the IMCC 904, intent monitoring information for intents and intent instances to monitor.

The process at 912 and 914 of FIG. 9 are the same as the process at 814 and 816 of FIG. 8.

At 916, IMT 908 sends an Event notification to IMCC 904 to inform the IMCC 904 about the impacted intent instance. The event notification may include intent instance information for the impacted intent instance, and event information described herein.

At 918, IMT 908 sends an Event notification to IAT 906 to inform the IAT 906 about the impacted intent instance. The event notification may include intent instance information for the impacted intent instance, and event information described herein.

The process at 920 and 922 are the same as the process at 818 and 820 of FIG. 8.

At 924, IAT 906 sends an Intent Instance notification to IMCC 904 to inform the IMCC 904 about changes to an intent instance. The Intent Instance notification may include intent instance information for the updated intent instance, and event information described herein.

The process at 926 is the same as the process at 822 of FIG. 8.

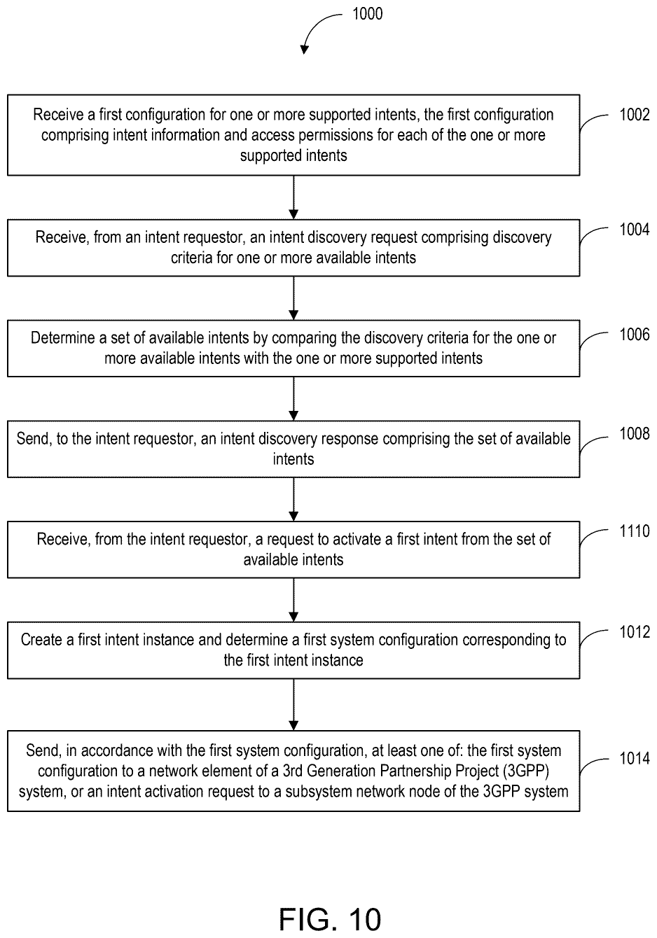

FIG. 10 is a flowchart of an example process 1000. In some implementations, one or more process blocks of FIG. 10 may be performed by a Network node.

As shown in FIG. 10, process 1000 may include, at 1002, receiving a first configuration for one or more supported intents, the first configuration having intent information and access permissions for each of the one or more supported intents. For example, a network node may receive a first configuration for one or more supported intents, the first configuration having intent information and access permissions for each of the one or more supported intents, as described above. As also shown in FIG. 10, process 1000 may include, at 1004, receiving, from an intent requestor, an intent discovery request having discovery criteria for one or more available intents. For example, the network node may receive, from an intent requestor, an intent discovery request having discovery criteria for one or more available intents, as described above. As further shown in FIG. 10, process 1000 may include, at 1006, determining a set of available intents by comparing the discovery criteria for the one or more available intents with the one or more supported intents. For example, the network node may determine a set of available intents by comparing the discovery criteria for the one or more available intents with the one or more supported intents, as described above. As also shown in FIG. 10, process 1000 may include, at 1008, sending, to the intent requestor, an intent discovery response having the set of available intents. For example, the network node may send, to the intent requestor, an intent discovery response having the set of available intents, as described above. As further shown in FIG. 10, process 1000 may include, at 1010 receiving, from the intent requestor, a request to activate a first intent from the set of available intents. For example, the network node may receive, from the intent requestor, a request to activate a first intent from the set of available intents, as described above. As also shown in FIG. 10, process 1000 may include, at 1012, creating a first intent instance and determining a first system configuration corresponding to the first intent instance. For example, the network node may create a first intent instance and determine a first system configuration corresponding to the first intent instance, as described above. As further shown in FIG. 10, process 1000 may include, at 1014, sending, in accordance with the first system configuration, at least one of: the first system configuration to a network element of a 3rd Generation Partnership Project (3GPP) system, or an intent activation request to a subsystem network node of the 3GPP system. For example, the network node may send, in accordance with the first system configuration, at least one of: the first system configuration to a network element of a 3rd Generation Partnership Project (3GPP) system, or an intent activation request to a subsystem network node of the 3GPP system, as described above.

Process 1000 may include additional implementations, such as any single implementation or any combination of implementations described below and/or in connection with one or more other processes described elsewhere herein. In a first implementation, the method may include creating the first intent instance may include: verifying the intent requestor is authorized to activate the first intent and there are no conflicts with the first intent; and assigning an intent identification (ID) to the first intent instance.

In a second implementation, alone or in combination with the first implementation, the first configuration further may include access permissions for each of the one or more supported intents, and where the discovery criteria may include at least one of: intent requestor information, user information, or discovery filters, and where the intent information may include at least one of: a respective intent identifier for each of the one or more supported intents, a respective intent group identifier for a group of the of the one or more supported intents, a respective intent name for each of the one or more supported intents, a respective intent type for each of the one or more supported intents, a respective intent category for each of the one or more supported intents, a respective intent description for each of the one or more supported intents, or a respective intent objective for each of the one or more supported intents.

A third implementation, alone or in combination with the first and second implementation, process 1000 further includes receiving wireless transmit/receive unit (WTRU) subscription and location information from a 3rd Generation Partnership Project (3GPP) system; and determining a subset of the one or more supported intents based on the WTRU subscription and location information.

A fourth implementation, alone or in combination with one or more of the first through third implementations, process 1000 further includes determining a first intent monitoring configuration based on intent activation information associated with the first intent instance; sending, to the intent requestor, a second response having an activation status of the first intent; monitoring the 3GPP system according to the first intent monitoring configuration; determining a first event associated with the first intent instance based on the monitoring; and sending, to the intent requestor, a first notification associated with the first event.

In a fifth implementation, alone or in combination with one or more of the first through fourth implementations, the first configuration is received from an intent provider, where the intent provider is at least one of: a second network node, or a wireless transmit/receive unit (WTRU), and where the intent requestor is at least one of: a network functional entity, an application server, an enabler server with intent requesting function (IRF) capabilities, or a wireless transmit/receive unit (WTRU).

In a sixth implementation, alone or in combination with one or more of the first through fifth implementations, the activation status of the first intent may include at least one of: an intent activation response, activation status information, one or more reasons for activation failure, or first intent instance information including an intent instance identification.

In a seventh implementation, alone or in combination with one or more of the first through sixth implementations, monitoring the 3GPP system may include at least one of: creating an intent monitoring task (IMT), or invoking commands or intents, either alone or in combination, associated with one or more 3GPP system application programming interfaces (APIs) or subsystem intent management functions (IMFs).

In an eighth implementation, alone or in combination with one or more of the first through seventh implementations, the first intent monitoring configuration may include invoking commands or intents, either alone or in combination, associated with one or more 3GPP system application programming interfaces (APIs) or subsystem intent management functions (IMFs).

In a ninth implementation, alone or in combination with one or more of the first through eighth implementations, the first network node is an intent management framework having at least one of: an intent management core component (IMCC), an intent semantics component (ISC), an intent activation task (IAT), an intent monitoring task (IMT), or an intent repository.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a first network node, the method comprising:
receiving a first configuration for one or more supported intents, the first configuration comprising intent information for each of the one or more supported intents;
receiving, from an intent requestor, an first intent discovery request comprising discovery criteria for one or more available intents;
determining a set of available intents by comparing the discovery criteria for the one or more available intents with the first configuration;
sending, to the intent requestor, an intent discovery response comprising the set of available intents;
receiving, from the intent requestor, a request to activate a first intent from the set of available intents;
creating a first intent instance and determining a first system configuration corresponding to the first intent instance; and
sending, in accordance with the first system configuration, at least one of: the first system configuration to a network element of a 3rd Generation Partnership Project (3GPP) system, or an intent activation request to a subsystem network node of the 3GPP system.

2. The method of claim 1, wherein creating the first intent instance comprises:
verifying the intent requestor is authorized to activate the first intent and there are no conflicts with the first intent; and
assigning an intent identification (ID) to the first intent instance.

3. The method of claim 2, wherein the first configuration further comprises access permissions for each of the one or more supported intents, and wherein the discovery criteria comprises at least one of: intent requestor information, user information, or discovery filters, and wherein the intent information comprises at least one of: a respective intent identifier for each of the one or more supported intents, a respective intent group identifier for a group of the of the one or more supported intents, a respective intent name for each of the one or more supported intents, a respective intent type for each of the one or more supported intents, a respective intent category for each of the one or more supported intents, a respective intent description for each of the one or more supported intents, or a respective intent objective for each of the one or more supported intents.

4. The method of claim 2, further comprising:
receiving wireless transmit/receive unit (WTRU) subscription and location information from a 3rd Generation Partnership Project (3GPP) system; and
determining a subset of the one or more supported intents based on the WTRU subscription and location information.

5. The method of claim 2, further comprising:
determining a first intent monitoring configuration based on intent activation information associated with the first intent instance;
sending, to the intent requestor, a second response comprising an activation status of the first intent;
monitoring the 3GPP system according to the first intent monitoring configuration;
determining a first event associated with the first intent instance based on the monitoring; and
sending, to the intent requestor, a first notification associated with the first event.

6. The method of claim 5, wherein the first configuration is received from an intent provider, wherein the intent provider is at least one of: a second network node, or a wireless transmit/receive unit (WTRU), and wherein the intent requestor is at least one of: a network functional entity, an application server, an enabler server with intent requesting function (IRF) capabilities, or a wireless transmit/receive unit (WTRU).

7. The method of claim 5, wherein the activation status of the first intent comprises at least one of: an intent activation response, activation status information, one or more reasons for activation failure, or first intent instance information including an intent instance identification.

8. The method of claim 5, wherein monitoring the 3GPP system comprises at least one of: creating an intent monitoring task (IMT), or invoking commands or intents, either alone or in combination, associated with one or more 3GPP system application programming interfaces (APIs) or subsystem intent management functions (IMFs).

9. The method of claim 5, wherein the first intent monitoring configuration comprises invoking commands or intents, either alone or in combination, associated with one or more 3GPP system application programming interfaces (APIs) or subsystem intent management functions (IMFs).

10. The method of claim 1, wherein the first network node is an intent management framework comprising at least one of: an intent management core component (IMCC), an intent semantics component (ISC), an intent activation task (IAT), an intent monitoring task (IMT), or an intent repository.

11. A first network node comprising:
processor circuitry; and
a transceiver configured to:
receive a first configuration for one or more supported intents, the first configuration comprising intent information and access permissions for each of the one or more supported intents; and
receive, from an intent requestor, an intent discovery request comprising discovery criteria for one or more available intents;
the processor circuitry configured to determine a set of available intents by comparing the discovery criteria for the one or more available intents with the one or more supported intents;
the transceiver configured to:
send, to the intent requestor, an intent discovery response comprising the set of available intents; and
receive, from the intent requestor, a request to activate a first intent from the set of available intents;
the processor circuitry configured to create a first intent instance and determining a first system configuration corresponding to the first intent instance; and
the transceiver configured to send, in accordance with the first system configuration, at least one of: the first system configuration to a network element of a 3rd Generation Partnership Project (3GPP) system, or an intent activation request to a subsystem network node of the 3GPP system.

12. The first network node of claim 11, wherein the processor is configured to:
verify the intent requestor is authorized to activate the first intent and there are no conflicts with the first intent; and
assign an intent identification (ID) to the first intent instance.

13. The first network node of claim 12, wherein the first configuration further comprises access permissions for each of the one or more supported intents, and wherein the discovery criteria comprises at least one of: intent requestor information, user information, or discovery filters, and wherein the intent information comprises at least one of: a respective intent identifier for each of the one or more supported intents, a respective intent group identifier for a group of the of the one or more supported intents, a respective intent name for each of the one or more supported intents, a respective intent type for each of the one or more supported intents, a respective intent category for each of the one or more supported intents, a respective intent description for each of the one or more supported intents, or a respective intent objective for each of the one or more supported intents.

14. The first network node of claim 12, wherein the transceiver if further configured to receive receiving wireless transmit/receive unit (WTRU) subscription and location information from a 3rd Generation Partnership Project (3GPP) system; and
the processor circuitry is further configured to determine a subset of the one or more supported intents based on the WTRU subscription and location information.

15. The first network node of claim 12, wherein the processor is configured to determine determining a first intent monitoring configuration based on intent activation information associated with the first intent instance;
the transceiver is configured to:
send, to the intent requestor, a second response comprising an activation status of the first intent; and
monitor the 3GPP system according to the first intent monitoring configuration;
the processor circuitry is configured to determine a first event associated with the first intent instance based on the monitoring; and
the transceiver is configured to send, to the intent requestor, a first notification associated with the first event.

16. The first network node of claim 15, wherein the first configuration is received from an intent provider, and wherein the intent provider is at least one of: a second network node, or a wireless transmit/receive unit (WTRU), and wherein the intent requestor is at least one of: a network functional entity, an application server, an enabler server with intent requesting function (IRF) capabilities, or a wireless transmit/receive unit (WTRU).

17. The first network node of claim 15, wherein the activation status of the first intent comprises at least one of: an intent activation response, activation status information, one or more reasons for activation failure, or first intent instance information including an intent instance identification.

18. The first network node of claim 15, wherein monitoring the 3GPP system comprises at least one of: creating an intent monitoring task (IMT), or invoking commands or intents, either alone or in combination, associated with one or more 3GPP system application programming interfaces (APIs) or subsystem intent management functions (IMFs).

19. The first network node of claim 15, wherein the first intent monitoring configuration comprises invoking commands or intents, either alone or in combination, associated with one or more 3GPP system application programming interfaces (APIs) or subsystem intent management functions (IMFs).

20. The first network node of claim 11, wherein the first network node is an internet management framework comprising at least one of: an intent management core component (IMCC), an intent semantics component (ISC), an intent activation task (IAT), an intent monitoring task (IMT), or an intent repository.
